(19) United States
(12) Patent Application Publication
(10) Pub. No.: US 2014/0060002 A1
(43) Pub. Date: Mar. 6, 2014

(54) REGENERATIVE TURBINE FOR POWER GENERATION SYSTEM

(71) Applicants: Chandrashekhar Sonwane, Canoga Park, CA (US); Kevin J. Lunde, Canoga Park, CA (US); Kenneth M. Sprouse, Canoga Park, CA (US)

(72) Inventors: Chandrashekhar Sonwane, Canoga Park, CA (US); Kevin J. Lunde, Canoga Park, CA (US); Kenneth M. Sprouse, Canoga Park, CA (US)

(21) Appl. No.: 13/604,201

(22) Filed: Sep. 5, 2012

(51) Int. Cl. F02C 3/04

(52) U.S. Cl. CPC F02C 3/04
USPC 60/39.182; 415/175; 60/772

(57) ABSTRACT

Disclosed is a power generation system and method. The system includes a combustor, and a turbine driven by products of the combustor. The turbine includes at least one disk supporting a plurality of airfoils, and the airfoils each have an internal passage formed therein. The system further includes a passage for routing a coolant within the system. A portion of the passage is provided by the internal passages of the airfoils, and another portion of the passage is provided between the airfoils and the combustor. The system also includes a generator driven by the turbine to generate electric power.

### BACKGROUND

Power plants are known and used. One known type of power plant is a coal-fired power plant that, in its simplest form, includes a combustor for combustion of coal to heat a coolant. The heated coolant, typically in the form of steam, drives a turbine, which in turn drives a generator to generate electricity. Another known type of power plant includes a combustor similar to that of a rocket engine. The combustor is fed a fuel and oxidizer, and a coolant is heated by the combustion of the fuel and oxidizer to drive a turbine and generate electric power.

### SUMMARY

A closed power generation system according to one embodiment of the present disclosure includes a turbine having an inlet, an outlet, and a cooling passage. The cooling passage further has an inlet and an outlet. The system includes a heat exchanger having an inlet and an outlet, and the inlet of the heat exchanger is in fluid communication with the outlet of the cooling passage. The outlet of the heat exchanger is in fluid communication with the inlet of the turbine. The system further includes a compressor having an inlet and an outlet, and the outlet of the compressor in fluid communication with both the inlet of the heat exchanger and the inlet of the cooling passage.

In a further non-limiting embodiment of the present disclosure, the heat exchanger is configured to heat a working fluid.

In a further non-limiting embodiment of the present disclosure, the heat exchanger is a first of two heat exchangers within the system, the second of the two heat exchangers has an inlet and an outlet, the inlet of the second heat exchanger is in fluid communication with the outlet of the turbine, and the outlet of the second heat exchanger is in fluid communication with the inlet of the compressor.

In a further non-limiting embodiment of the present disclosure, the second heat exchanger is configured to provide heat rejection relative to a working fluid.

In a further non-limiting embodiment of the present disclosure, the system includes a main system loop directs a working fluid between the compressor, the first heat exchanger, the turbine, and the second heat exchanger.

In a further non-limiting embodiment of the present disclosure, the system includes a cooling loop in communication with the cooling passage of the turbine and with the main system loop.

In a further non-limiting embodiment of the present disclosure, the cooling loop is sourced from the main system loop at a point between the first and second heat exchangers, and the cooling loop is returned to the main system loop at a point upstream of the first heat exchanger.

In a further non-limiting embodiment of the present disclosure, a portion of the cooling passage is provided within the interior of a turbine airfoil.

In a further non-limiting embodiment of the present disclosure, a portion of the cooling passage is provided within a turbine disk.

An open power generation system according to another embodiment of this disclosure includes a turbine having an inlet, an outlet, and a cooling passage. The cooling passage further has an inlet and an outlet. The system includes a combustor having an inlet and an outlet, and the outlet of the combustor is in fluid communication with the inlet of the turbine. The inlet of the combustor is in fluid communication with the outlet of the cooling passage. The system further includes a compressor having an inlet and an outlet, the inlet of the compressor is in fluid communication with the outlet of the turbine, and the outlet of the compressor is in fluid communication with the inlet of the cooling passage.

In a further non-limiting embodiment of the present disclosure, the turbine includes a plurality of airfoils each having an internal passage formed therein, the internal passages of the airfoils providing a portion of the cooling passage.

In a further non-limiting embodiment of the present disclosure, the system includes a generator operable to be driven by the turbine to generate electric power.

In a further non-limiting embodiment of the present disclosure, the system includes a coolant source in communication with the inlet of the cooling passage.

In a further non-limiting embodiment of the present disclosure, a compressor is provided between the coolant source and the inlet of the cooling passage.

In a further non-limiting embodiment of the present disclosure, the combustor is provided with fuel, oxidizer, and the coolant, and wherein the products of combustor provide the turbine with a working fluid including the combusted fuel, oxidizer, and coolant.

In a further non-limiting embodiment of the present disclosure, the fuel includes natural gas, the oxidizer includes oxygen, and the coolant includes supercritical carbon dioxide (SCO₂).

In a further non-limiting embodiment of the present disclosure, the system includes a separator configured to separate coolant from the remaining products of the combustor, the separated coolant directed to an inlet of the cooling passage.

In a further non-limiting embodiment of the present disclosure, the system includes a compressor provided between the separator and the cooling passage to pressurize the separated coolant.

In a further non-limiting embodiment of the present disclosure, the separator includes at least one compressor stage, the at least one compressor stage being selected from the group consisting of a pre-compressor stage, a main stage, and a post compressor stage.

In a further non-limiting embodiment of the present disclosure, a portion of the cooling passage is provided within at least one of the interior of a turbine airfoil and a turbine disk.

A method of operating a power generation system according to the present disclosure includes driving a turbine with products of a combustor, cooling airfoils of the turbine with a coolant, and, after cooling the airfoils, directing the coolant from the airfoils to the combustor for combustion.

In a further non-limiting embodiment of the present disclosure, the coolant is separated from the products of the combustor.

In a further non-limiting embodiment of the present disclosure, the airfoils are cooled with coolant separated from the products of the combustor.

In a further non-limiting embodiment of the present disclosure, the airfoils are cooled with coolant provided from one of a coolant source and a fuel source.

In a further non-limiting embodiment of the present disclosure, the airfoils are selected from the group consisting of turbine blades and stator vanes.

These and other features of the present disclosure can be best understood from the following drawings and detailed description.

### BRIEF DESCRIPTION OF THE DRAWINGS

The drawings can be briefly described as follows:

FIG. 1 is a schematic view of an example of a closed power generation system.

FIG. 2 is a schematic view of an example of an open power generation system.

FIG. 3 illustrates a cross-sectional view of an example turbine blade.

FIG. 4 illustrates an example flow path of coolant within a cooling passage of a turbine.

FIG. 5 is a schematic view of a second example of an open power generation system.

FIG. 6 is a schematic view of a third example of an open power generation system.

### DETAILED DESCRIPTION

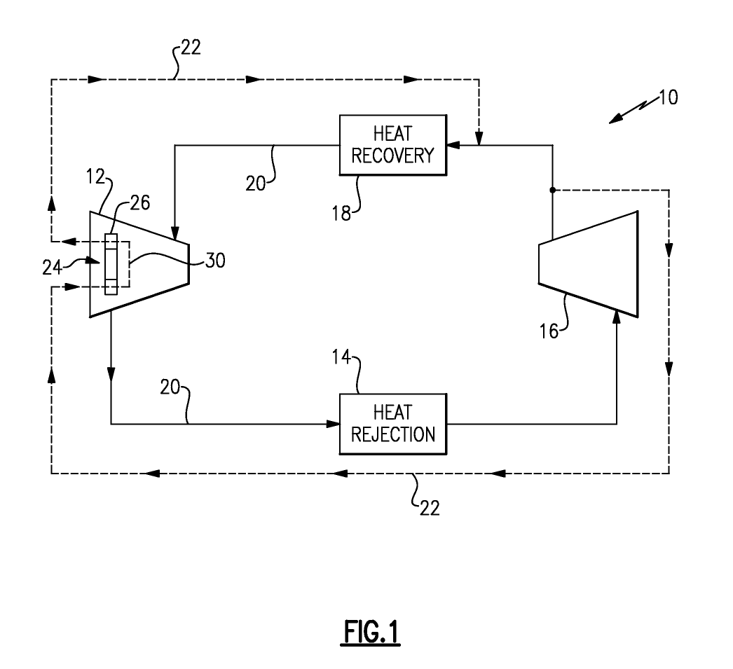

FIG. 1 is a schematic view of an example of a closed power generation system 10 (“system 10”). In this example, the system 10 includes many elements of a typical Brayton cycle: a turbine 12, a heat rejection process 14, a compressor 16, and a heat recovery process 18. The heat rejection and recovery processes 14, 18 include heat exchangers in one example, and are configured to remove heat, and add heat, respectively, relative to a working fluid within a main system loop 20.

This disclosure is not limited to any one particular type of working fluid. Example working fluids include supercritical carbon dioxide (SCO₂), as well as mixtures of (1) supercritical carbon dioxide (SCO₂) and natural gas, (2) supercritical carbon dioxide (SCO₂) and impurities (such as argon (Ar)), and (3) supercritical carbon dioxide (SCO₂) and water (H₂O). The working fluid could further include carbon dioxide (CO₂), syngas, or a light distillate oil obtained from crude oil.

Turning back to FIG. 1, the system 10 further includes a regenerative cooling loop 22. As illustrated, the cooling loop 22 branches from the main system loop 20 at a point between the heat rejection process 14 and the heat recovery process 18, in this example between the compressor 16 and the heat recovery process 18. Coolant within the cooling loop 22 is directed toward a cooling passage within the turbine 12 to cool the turbine. A cooling passage 30 is provided within the turbine 12, in which the coolant from the cooling loop 22 absorbs heat (e.g., the heat from the working fluid 20 expanding within the turbine). Downstream of the turbine 12, the coolant is directed back to the main system loop 20, here at a point between the heat recovery process 18 and the compressor 16. Providing the heated coolant back into the main system loop 20 at this point increases the efficiency of the heat recovery process 18. As those in this art will appreciate, the system 10 of FIG. 1 has “closed-loop,” or “closed,” functionality.

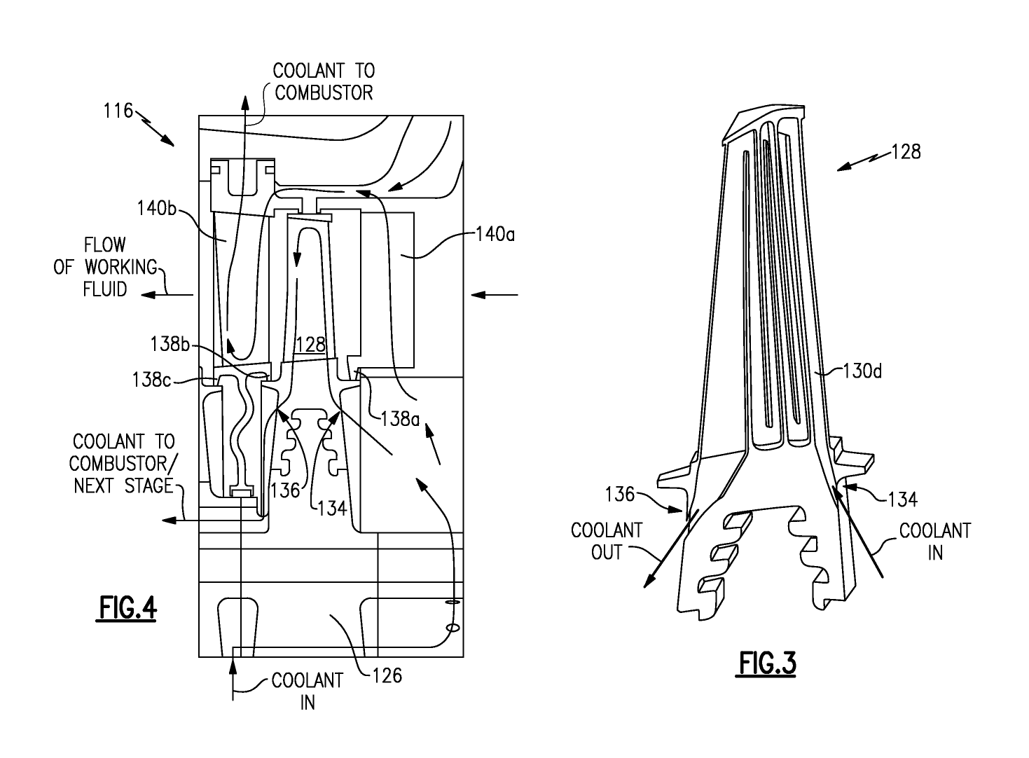

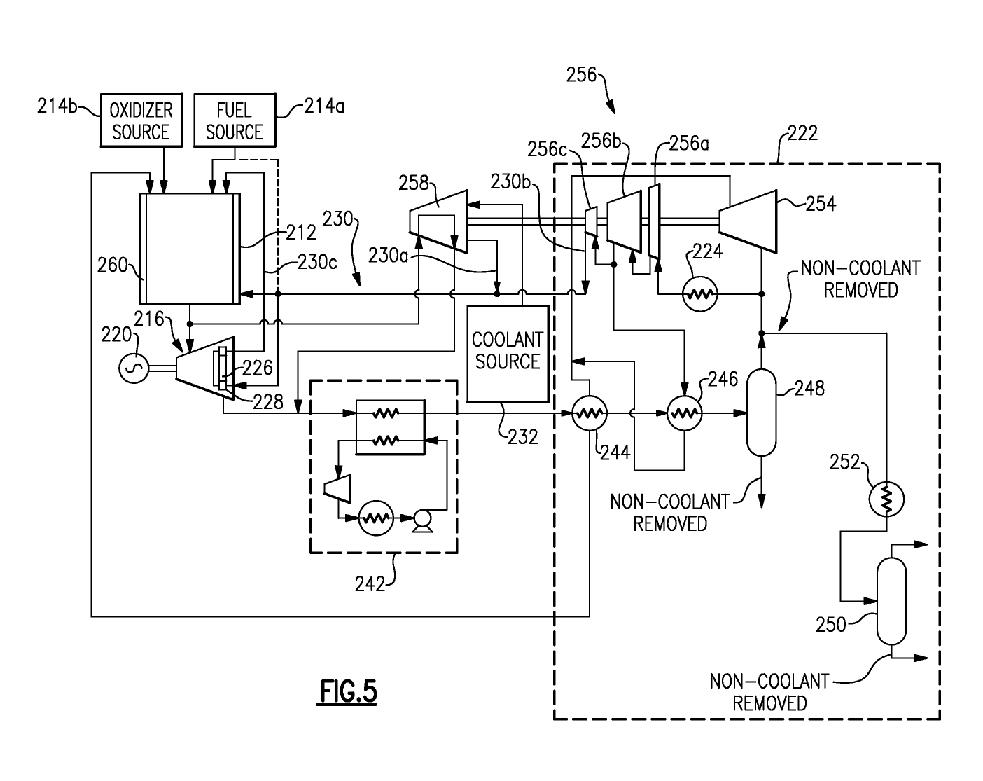

In the illustrated example, the turbine 12 includes at least one stage including a disk 24 which supports a plurality of blades 26 about the outer periphery thereof. The cooling passage 30 within the turbine 12, in the example, extends through an internal passage provided in the turbine blades 26. An example internal passage is illustrated in FIG. 4. Alternatively, or additionally, the cooling passage 30 within the turbine 12 extends through the disk 24. The cooling passage 30 could further extend through stator vanes, or any other desired turbine components.

Generally, in systems such as the system 10, the efficiency of the system increases with an increasing temperature of the working fluid being expanded within the turbine 12. High working fluid temperatures, however, can damage the components of the turbine 12. The relatively cool coolant within the cooling passage 30 cools the various components of the turbine 12, and in particular the blades 26, and thus allows the turbine 12 to be exposed to a relatively hot working fluid, leading to increased efficiency.

While the terms “coolant” and “working fluid” are used herein, it should be understood that the two terms could refer to the same type of fluid. That is, in one example, the coolant within the cooling loop 22 is the same type of fluid as the working fluid. In another example, such as in the examples below, there is a separation process that separates a coolant from the working fluid.

As mentioned, the system 10 of FIG. 1 is a closed system. This disclosure extends to other power generation systems, including open systems, such as those discussed below.

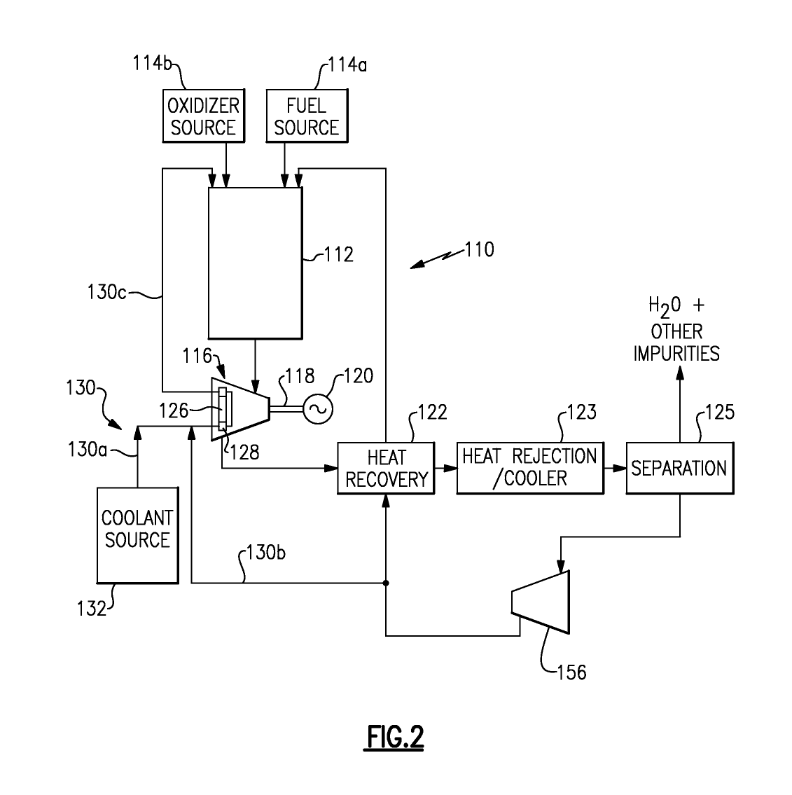

FIG. 2 is a schematic view of selected portions of an example of an open power generation system 110 (“system 110”). The system 110 in this example includes a combustor 112 that is similar to combustors used in rocket engines. In other examples, the system 110 could include another type of combustor, such as coal-fired boiler. While particular examples of systems are shown and described, it should be understood that this disclosure extends to other types of systems.

In the illustrated example, the combustor 112 is in communication with fuel and oxidizer sources, 114a, 114b. Downstream of the combustor 112 is a turbine 116 that is mounted on a shaft 118 which is coupled to a generator 120 for generating electric power. Downstream of the turbine 116 is a heat recovery process 122, a heat rejection process 123 configured to reduce the temperature of the coolant for further use in the system 110, and a coolant separator 125 configured to, among other things, recover coolant from the products of the combustor 112, which are generally referred to herein as a working fluid. Downstream of the separator 125 is a compressor 156 configured to pressurize the coolant before being routed back to the combustor 112 or the turbine 116.

The turbine 116 includes at least one stage including a disk 126 which supports a plurality of blades 128 about the outer periphery thereof. As generally mentioned above relative to the system 10, the efficiency of the system 110 increases with the increasing temperature of the working fluid used to drive the turbine 116. To prevent damage to the turbine 112, the system 110 includes a regenerative cooling line 130 (“line 130”) configured to route relatively cool coolant through the turbine blades 128, in one example, thus cooling the blades 128 and allowing the blades 128 to be exposed to relatively hot fluid from the combustor 112.

The line 130 includes a portion 130a between a source of relatively cool coolant source 132 and the blades 128, as well as a portion 130b between the cooler 124 and the turbine blades 128. The line 130 further includes a portion 130c configured to route the relative warm cooling fluid from the blades 128 back to the combustor 112.

Turning to FIG. 3, an example turbine blade 128 is illustrated. The example turbine blade 128 includes an internal line 130d that includes an inlet 134 at a leading edge of the root of the blade 128, and an outlet 136 at a trailing edge of the root of the blade. The internal line 130d provides a portion of the overall line 130, and additionally provides a portion of cooling passage of the turbine 116. In this example, the internal line 130d defines a serpentine shape throughout the interior of the blade 128. The internal line 130d could have any desired shape, however. Further, in some embodiments the internal line 130d is a microchannel, which is known in the art as a channel with a hydraulic diameter below 1 mm (0.039 in).

FIG. 4 illustrates an example flow path of the coolant through a cooling passage provided within the turbine 116. In the example, to cool the blades 128, the coolant enters the inlet 134, passes through the internal passage of the blade 130d, and exits the outlet 136. From there, the coolant travels axially downstream either to the next stage of turbine blades, or back to the combustor 112. A series of seals 138a, 138b, 138c, reduces the amount of coolant entering into the flow path of the working fluid, which is expanded over the turbine blades 128 to drive the turbine 116.

Optionally, stator vanes, such as stator vanes 140a, 40b, can be provided with internal passages configured to receive the relatively cool coolant in a manner similar to the turbine blades 128. The stator vanes 140a, 140b and turbine blades 128 are generically referred to herein as “airfoils.” In the illustrated example, an upstream stator vane 40a is provided with a flow of cool coolant, and that coolant flows downstream to cool another stator vane 140b. After each stage of stator vanes is cooled, the coolant is returned to the combustor 112.

In one example, the coolant used to cool the blades and/or vanes is supercritical carbon dioxide (SCO₂). Supercritical carbon dioxide is known as a fluid state of carbon dioxide (CO₂) held at or above its critical temperature and critical pressure. In this example, the fuel provided by the fuel source 114a is natural gas and the oxidizer provided by the oxidizer source 114b is oxygen. The working fluid, which includes the products of the combustion of supercritical carbon dioxide (SCO₂), oxygen (O₂), and natural gas, is primarily water (H₂O) and carbon dioxide (CO₂), at least some of which is supercritical carbon dioxide (SCO₂).

The working fluid can be heated, by the combustor 112, to high temperatures to efficiently drive the turbine 116, and, after driving the turbine 116, the working fluid can be processed such that the coolant, in this example supercritical carbon dioxide (SCO₂), is separated therefrom, using known techniques including water separators, for example. The supercritical carbon dioxide (SCO₂) can then be recooled for use as a coolant for the turbine blades 128.

Accordingly, the disclosed system makes efficient use of the products of the combustor, and allows the turbine to operate efficiently while being driven by a working fluid having a relatively high temperature.

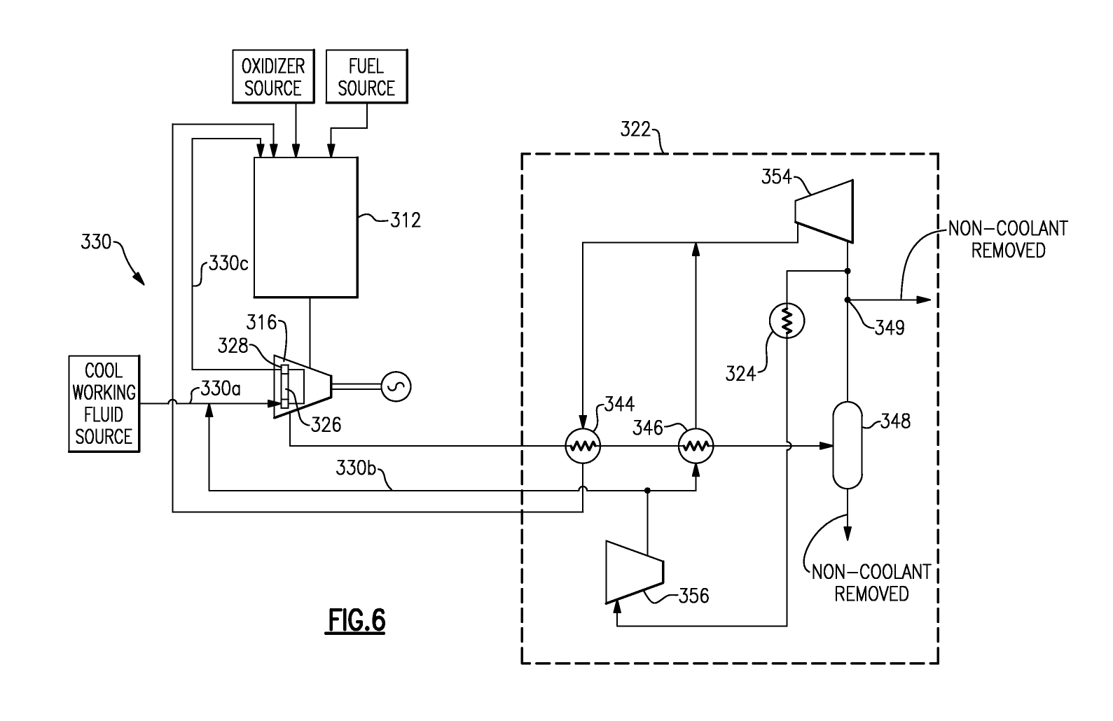

FIG. 5 illustrates another example of an open power generation system. To the extent not otherwise described or shown, the reference numerals in FIG. 5 correspond to those of FIG. 2, with like parts having reference numerals preappended with a “2.”

In the example of FIG. 5, an optional steam Rankine cycle 242 is downstream of the turbine 216. If included, the steam Rankine cycle 242 can be used to generate additional power from the relatively hot working fluid from of the combustor 212.

Further downstream of the turbine 216 is the heat recovery process 222. In this example, the heat recovery process 222 includes first and second recuperators 244, 246, as well as first and second separators 248, 250. Another recuperator 252 is between the separators 248 and 250. It is not necessary to include the redundant separators 248, 250, and it instead may be sufficient to only include one separator, depending on the application.

Downstream of the separator 248 is a cooler 224. The heat recovery process 222 further includes a compressor 256. In this example, the compressor 256 includes three stages arranged on a common shaft 259. A pre-compressor stage 256a is configured to compress the relatively cool recovered coolant before that fluid is again compressed by a main stage 256b. Following the main stage 256b, fluid is either provided to the recuperator 246, or to a post-compressor stage 256c. The post-compressor stage 256c compresses the fluid and provides the fluid to the line 230b, which is in communication with the turbine blades 228, at a relatively high pressure. While a particular compressor 256 is shown, this disclosure extends to other compressor types.

The turbine blades 228 are also in communication with relatively cool coolant from the source 232 by way of a turbo compressor 258. The turbo compressor 258 is driven by products of the combustor 212 which, in this example, are tapped upstream of the turbine 216 and returned downstream of the turbine 216. The turbo-compressor 258 further drives the compressors 256, 254 by way of a shaft 259.

In the example, the combustor 212 includes a cooling jacket 260 which serves to cool the outer walls of the combustor 212. The cooling jacket 260 can either be cooled by fuel from the fuel source 214a or the relatively cool coolant. This cooling feature allows the combustor 212 to provide relatively hot combustion products to the turbine 216, which again makes the overall system more efficient.

FIG. 6 illustrates yet another example of an open power generation system. To the extent not otherwise described or shown, the reference numerals in FIG. 6 correspond to those of FIG. 2, with like parts having reference numerals preappended with a “3.”

FIG. 6 includes another example heat recovery process 322. The heat recovery process 322 includes only one separator, the separator 348. However, it should be noted that additional non-coolant is removed at a point downstream of the separator 348, at 349. In the example where the coolant is supercritical carbon dioxide (SCO₂), carbon dioxide (CO₂) that is not supercritical would be removed, or sequestered, at 349. The removed carbon dioxide (CO2) could optionally be further processed and reintroduced into the system as supercritical carbon dioxide (SCO₂).

As mentioned above, this disclosure is not limited to the particularities of the structure associated with the systems illustrated in the figures. Particularly, while various heat recovery processes have been illustrated as examples, it should be understood that modifications of the illustrated systems come within the scope of this disclosure. Further, and again, the systems illustrated in the various figures are not limited to a particular coolant type.

Additionally, while the fuel provided by the fuel source 114a, for example, has been discussed as being natural gas, this disclosure could use hydrogen (H₂), argon (Ar), or a mixture of argon (Ar) and carbon dioxide (CO₂). If a fuel other than natural gas is used, however, further processing (that is not disclosed, but is generally known in the art) would be required to extract the coolant from the products of the combustor 112.

This application can further be used for both new power generation systems, and as a basis for retrofitting existing power generation systems. That is, whereas most existing systems simply exhaust the products of their combustor, an existing system could be fit with a coolant separator, and a line (such as the line 130) configured to, among other things, route relatively cool coolant to cool the components of the turbine.

While not specifically mentioned above, it should be understood that the various components in the Figures are provided with inlets, and outlets, as necessary to provide the illustrated fluid communication therebetween. For example, relative to FIG. 1, the turbine 16 has an inlet and outlet for the working fluid within the main system loop 20, and further has separate inlets and outlets for the cooling passage 30 to receive coolant from the cooling loop 22. These inlets and outlets can be provided in known ways, using fittings or the like, as is known in the art.

Although the different examples have the specific components shown in the illustrations, embodiments of this invention are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

What is claimed is:

1. A closed power generation system comprising:
a turbine having an inlet, an outlet, and a cooling passage, the cooling passage having an inlet and an outlet;
a heat exchanger having an inlet and an outlet, the inlet of the heat exchanger in fluid communication with the outlet of the cooling passage, the outlet of the heat exchanger in fluid communication with the inlet of the turbine; and
a compressor having an inlet and an outlet, the outlet of the compressor in fluid communication with both the inlet of the heat exchanger and the inlet of the cooling passage.

2. The system as recited in claim 1, wherein the heat exchanger is configured to heat a working fluid.

3. The system as recited in claim 1, wherein the heat exchanger is a first of two heat exchangers within the system, the second of the two heat exchangers having an inlet and an outlet, the inlet of the second heat exchanger in fluid communication with the outlet of the turbine, and the outlet of the second heat exchanger in fluid communication with the inlet of the compressor.

4. The system as recited in claim 3, wherein the second heat exchanger is configured to provide heat rejection relative to a working fluid.

5. The system as recited in claim 3, including a main system loop for directing a working fluid between the compressor, the first heat exchanger, the turbine, and the second heat exchanger.

6. The system as recited in claim 5, including a cooling loop in communication with the cooling passage of the turbine and with the main system loop.

7. The system as recited in claim 6, wherein the cooling loop is sourced from the main system loop at a point between the first and second heat exchangers, and wherein the cooling loop is returned to the main system loop at a point upstream of the first heat exchanger.

8. The system as recited in claim 1, wherein a portion of the cooling passage is provided within the interior of a turbine airfoil.

9. The system as recited in claim 1, wherein a portion of the cooling passage is provided within a turbine disk.

10. An open power generation system comprising:
a turbine having an inlet, an outlet, and a cooling passage, the cooling passage having an inlet and an outlet;
a combustor having an inlet and an outlet, the outlet of the combustor in fluid communication with the inlet of the turbine, the inlet of the combustor in fluid communication with the outlet of the cooling passage; and
a compressor having an inlet and an outlet, the inlet of the compressor in fluid communication with the outlet of the turbine, the outlet of the compressor in fluid communication with the inlet of the cooling passage.

11. The system as recited in claim 10, wherein the turbine includes a plurality of airfoils each having an internal passage formed therein, the internal passages of the airfoils providing a portion of the cooling passage.

12. The system as recited in claim 10, including a generator operable to be driven by the turbine to generate electric power.

13. The system as recited in claim 10, including a coolant source in communication with the inlet of the cooling passage.

14. The system as recited in claim 13, wherein a compressor is provided between the coolant source and the inlet of the cooling passage.

15. The system as recited in claim 10, wherein the combustor is provided with fuel, oxidizer, and the coolant, and wherein the products of combustor provide the turbine with a working fluid including the combusted fuel, oxidizer, and coolant.

16. The system as recited in claim 15, wherein the fuel includes natural gas, the oxidizer includes oxygen, and the coolant includes supercritical carbon dioxide (SCO₂).

17. The system as recited in claim 15, including a separator configured to separate coolant from the remaining products of the combustor, the separated coolant directed to an inlet of the cooling passage.

18. The system as recited in claim 17, including a compressor provided between the separator and the cooling passage to pressurize the separated coolant.

19. The system as recited in claim 18, wherein the separator includes at least one compressor stage, the at least one compressor stage being selected from the group consisting of a pre-compressor stage, a main stage, and a post compressor stage.

20. The system as recited in claim 18, wherein a portion of the cooling passage is provided within at least one of the interior of a turbine airfoil and a turbine disk.

21. A method of operating a power generation system, the method comprising:
driving a turbine with products of a combustor;
cooling airfoils of the turbine with a coolant; and
after cooling the airfoils, directing the coolant from the airfoils to the combustor for combustion.

22. The method as recited in claim 21, including separating the coolant from the products of the combustor.

23. The method as recited in claim 22, wherein the airfoils are cooled with coolant separated from the products of the combustor.

24. The method as recited in claim 21, wherein the airfoils are cooled with coolant provided from one of a coolant source and a fuel source.

25. The method as recited in claim 21, wherein the airfoils are selected from the group consisting of turbine blades and stator vanes.
